(19) United States
(12) Patent Application Publication
(10) Pub. No.: US 2025/0173199 A1
(43) Pub. Date: May 29, 2025

(54) BUILDING WEB APPLICATION PROGRAMMING INTERFACES IN CLOUD SYSTEMS

(71) Applicant: SAP SE, Walldorf (DE)

(72) Inventors: Dabin Feng, Shanghai (CN); Jie Yu, Shanghai (CN); Haijing Lin, Shanghai (CN); Xia Yu, Shanghai (CN)

(21) Appl. No.: 18/519,220

(22) Filed: Nov. 27, 2023

(51) Int. Cl. G06F 9/54

(52) U.S. Cl. CPC G06F 9/541

(57) ABSTRACT

Methods, systems, and computer-readable storage media for receiving, by a static code analyzer, API metadata descriptive of an API that is to be deployed to a cloud computing environment to enable access to a service, processing, by the static code analyzer, the API metadata to retrieve source code that encodes functionality of the service and process the source code to generate a code structure that is descriptive of the source code, generating, by an API generator, boilerplate code and glue code for the API using the API metadata and the code structure, and deploying the API to the cloud computing environment.

### BACKGROUND

On-premise applications can be described as software that is located within the physical confines of an enterprise (e.g., in a data center owned by and/or operated on behalf of an enterprise). However, there has been a move toward off-premise applications that are executed in cloud computing environments (e.g., applications provided in the so-called “Software-as-a-Service” (SaaS) paradigm). Cloud computing can be described as Internet-based computing that provides shared computer processing resources, and data to computers and other devices on demand.

In the context of cloud platforms, applications can be provided in a so-called service-oriented architecture (SOA). For example, an application can be composed of or otherwise rely on a set of services in a service stack (e.g., a stack of services in which one or more services can each depend on one or more other services). A service can be provided as one or more computer-executable programs. In some examples, the services, which can also be referred to as micro-services, are reusable (e.g., multiple applications can include the same service). A service can be accessed through a respective application programming interface (API).

### SUMMARY

Implementations of the present disclosure are directed to development and deployment of application programming interfaces (APIs) to consume services in cloud computing environments. More particularly, implementations of the present disclosure are directed to an API development platform that leverages metadata and coded logic to enable resource- and time-efficient development and deployment of APIs in cloud computing environments.

In some implementations, actions include receiving, by a static code analyzer, API metadata descriptive of an API that is to be deployed to a cloud computing environment to enable access to a service, processing, by the static code analyzer, the API metadata to retrieve source code that encodes functionality of the service and process the source code to generate a code structure that is descriptive of the source code, generating, by an API generator, boilerplate code and glue code for the API using the API metadata and the code structure, and deploying the API to the cloud computing environment. Other implementations of this aspect include corresponding systems, apparatus, and computer programs, configured to perform the actions of the methods, encoded on computer storage devices.

These and other implementations can each optionally include one or more of the following features: the code structure is generated by providing, by a tokenizer of the static code analyzer, a set of tokens from the source code, generating, by a parser of the static code analyzer, a syntax tree using the set of tokens, and defining, by an analyzer, the code structure from the syntax tree; the set of tokens includes a list of objects representing categorized input characters; generating, by an API generator, boilerplate code and glue code for the API includes reading the code structure generated by the static code analyzer and the API metadata, and combining at least a portion of the code structure and at least a portion of the API metadata; the API metadata is stored in an extensible markup language (XML) file and includes a protocol, a language, a path, and a source code mapping; the source code is retrieved based on the source code mapping; and deploying the API to the cloud computing environment is performed in response to validating the API.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIG. 3 depicts a representation of static code analysis in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to development and deployment of application programming interfaces (APIs) to consume services in cloud computing environments. More particularly, implementations of the present disclosure are directed to an API development platform that leverages metadata and coded logic to enable resource- and time-efficient development and deployment of APIs in cloud computing environments. Implementations can include actions of receiving, by a static code analyzer, API metadata descriptive of an API that is to be deployed to a cloud computing environment to enable access to a service, processing, by the static code analyzer, the API metadata to retrieve source code that encodes functionality of the service and process the source code to generate a code structure that is descriptive of the source code, generating, by an API generator, boilerplate code and glue code for the API using the API metadata and the code structure, and deploying the API to the cloud computing environment.

To provide further context for implementations of the present disclosure, and as introduced above, there has been a move toward off-premise applications that are executed in cloud computing environments (e.g., applications provided in the so-called “Software-as-a-Service” (SaaS) paradigm). Cloud computing can be described as Internet-based computing that provides shared computer processing resources, and data to computers and other devices on demand. In the context of cloud platforms, applications can be provided in a so-called service-oriented architecture (SOA). For example, an application can be composed of or otherwise rely on a set of services in a service stack (e.g., a stack of services in which one or more services can each depend on one or more other services).

A service can be provided as one or more computer-executable programs. In some examples, the services, which can also be referred to as micro-services, are reusable (e.g., multiple applications can include the same service). Each service can be accessed through a respective API. Here, it can be said that a call can be made to a service through a respective API to consume the service (e.g., provide input to the service to perform some functionality). For example, aspects of user interfaces (UIs), data integration, service-to-service communication, and the like can be considered, which can be achieved using APIs.

The above-mentioned migration of applications to cloud platforms implicates provisioning of an increasing number of services within a cloud platform and, for each service, providing a respective API to enable consumption of the service. Hence, there is a need for relatively rapid development and deployment of APIs in increasingly higher numbers. However, developing and deploying APIs is a non-trivial task that not only consumes technical resources, but also requires technical expertise.

For example, a backend developer can be tasked with building boilerplate code and glue code to implement APIs corresponding to multiple, disparate API protocols (e.g., REST, OData, gRPC). In the context of the present disclosure, boilerplate code refers to sections of code that have to be included in the API with little or no alteration, and glue code refers to sections of code that function as an adapter between otherwise incompatible parts the API. However, the code is absent logic that can be required to consume a service, and the API protocols present a tough learning curve for proficiency and knowledge. To assist developers on boilerplate code, some API frameworks (such as gRPC) provide capability to generate skeletons that can be used to save boilerplate code for reuse. However, developers still have to build glue code. Further, such API frameworks cannot support incremental generation and changes have to be merged by developers.

In view of the above context, implementations of the present disclosure provide an API development platform that enables resource- and time-efficient development and deployment of APIs in cloud computing environments. The API development platform of the present disclosure leverages metadata and coded logic to generate boilerplate code and glue code, while automatically handling API protocols. As described in further detail herein, the API development platform of the present disclosure enables saving of boilerplate code and glue code, obviates the need for expert-level proficiency in API protocols, and enables flexible, resource-efficient, protocol-agnostic and programming language-agnostic building of APIs.

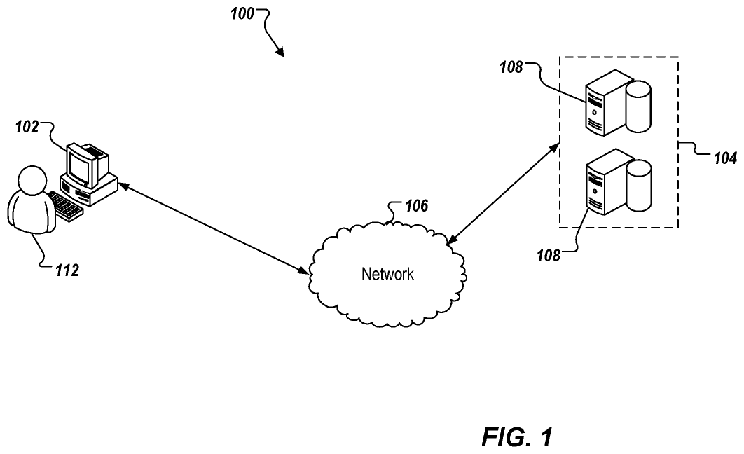

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In some implementations of the present disclosure, the server system 104 can host one or more services that are accessible through respective APIs. For example, the server system 104 can provide a cloud computing environment, within which services are executed and are accessible through respective APIs. Each service is provisioned within the cloud computing environment as computer-executable binary code that is generated from source code. For example, the source code is developed by one or more users (e.g., developers) and encodes functionality (logic) that is to be performed by the service. The source code is compiled to binary code that is executed in the cloud computing environment. In accordance with implementations of the present disclosure, the server system 104 can host an API development platform that leverages metadata and the source code (coded logic) to enable resource- and time-efficient development and deployment of APIs in the cloud computing environment for the services.

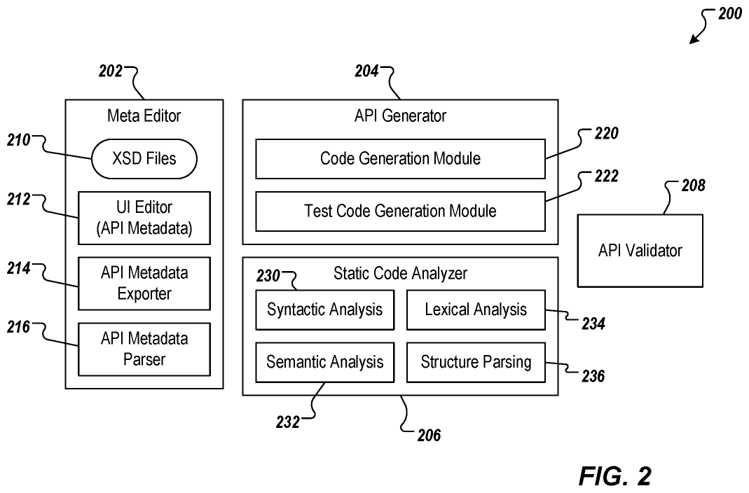

FIG. 2 depicts an example conceptual architecture 200 in accordance with implementations of the present disclosure. In the depicted example, the conceptual architecture 200 includes a meta editor 202, an API generator 204, a static code analyzer 206, and an API validator 208. The meta editor 302 includes a file store 210, a UI editor 212, and API metadata exporter 214, and an API metadata parser 216. The API generator 204 includes a code generation module 220 and a test code generation module 222. The static code analyzer 206 includes a syntactic analysis module 230, a semantic analysis module 232, a lexical analysis module 234, and a structure parsing module 236.

In some implementations, the meta editor 202 enables users (e.g., developers) to define and generate API metadata. In some examples, the meta editor 202 provides a set of extensible markup language (XML) schema definition (XSD) files with different protocols and programming languages. In some examples, users can use the XSD files to define API metadata and generate an XML file. For example, the user can interact with functionality of the meta editor 202 through a UI provisioned by the UI editor 212 to, for example, access XSD files in the file store 210 and define API metadata. Example API metadata can include, without limitation, protocol (e.g., REST, OData, gRPC), language (e.g., Java, Javascript, C#), path (API uniform resource indicator (URI)), and operation (e.g., hypertext transfer protocol (HTTP) method (such as GET, POST, etc.), parameters, one or more source code mappings). The API metadata can be exported by the API metadata exporter 214 and parsed by the API metadata parser 216. In some examples, the API metadata is consumed by the API generator 204, as described in further detail herein. In some examples, users can upload an XML file that provides API metadata and can use the meta editor 202 to edit the API metadata.

In general, content of an XSD file describes and validates a structure and content of an XML document that is recorded in an XML file. For example, content of the XSD file defines the elements, attributes, and data types the XML document can contain. The content of the XSD file is used to verify whether each element, attribute, and data type in the XML document matches its description. Listing 1 provides non-limiting, example contents of an XSD file:
<?xml version=“1.0” encoding=“UTF-8”?>
<xs:schema xmlns:xs=“http://www.w3.org/2001/XMLSchema” attributeFormDefault=“unqualified” elementFormDefault=“qualified”>
   <xs:element name=“OmnipotentApi” type=“OmnipotentApiType”/>
   <xs:complexType name=“parameterType”>
      <xs:all>
      <xs:element name=“name” type=“xs:string”/>
         <xs:element name=“type”>
         <xs:simpleType>
         <xs:restriction base=“xs:string”>
         <xs:enumeration value=“string”/>
         <xs:enumeration value=“integer”/>
         <xs:enumeration value=“long”/>
         <xs:enumeration value=“boolean”/>
         <xs:enumeration value=“date”/>
         <xs:enumeration value=“time”/>
         <xs:enumeration value=“timestamp”/>
         </xs:restriction>
         </xs:simpleType>
         </xs:element>
         <xs:element type=“xs:string” name=“scope” minOccurs=“0”/>
      </xs:all>
   </xs:complexType>
   <xs:complexType name=“parametersType”>
      <xs:sequence>
         <xs:element type=“parameterType” name=“parameter” maxOccurs=“unbounded” minOccurs=“O”/>
      </xs:sequence>
   </xs:complexType>
   <xs:complexType name=“getType”>
      <xs:all>
         <xs:element type=“parametersType” name=“parameters” minOccurs=“0”/>
         <xs:element type=“sourceType” name=“source”/>
      </xs:all>
   </xs:complexType>
   <xs:complexType name=“postType”>
      <xs:all>
         <xs:element type=“parametersType” name=“parameters” minOccurs=“0”/>
         <xs:element type=“sourceType” name=“source”/>
      </xs:all>
   </xs:complexType>
   <xs:complexType name=“pathType”>
      <xs:all>
         <xs:element name=“value” type=“xs:string”/>
         <xs:element type=“getType” name=“get” minOccurs=“0”/>
         <xs:element type=“postType” name=“post” minOccurs=“0”/>
      </xs:all>
   </xs:complexType>
   <xs:complexType name=“pathsType”>
      <xs:sequence>
         <xs:element type=“pathType” name=“path” maxOccurs=“unbounded” minOccurs=“0”/>
      </xs:sequence>
   </xs:complexType>
   <xs:complexType name=“sourceType”>
      <xs:all>
         <xs:element type=“xs:string” name=“controller”/>
         <xs:element type=“xs:string” name=“handlerMethod”/>
      </xs:all>
   </xs:complexType>
   <xs:complexType name=“OmnipotentApiType”>
      <xs:all>
         <xs:element name=“protocol”>
         <xs:simpleType>
         <xs:restriction base=“xs:string”>
         <xs:enumeration value=“rest”/>
         <xs:enumeration value=“odata”/>
         <xs:enumeration value=“gRPC”/>
         </xs:restriction>
         </xs:simpleType>
         </xs:element>
         <xs:element name=“language”>
         <xs:simpleType>
         <xs:restriction base=“xs:string”>
         <xs:enumeration value=“java”/>
         <xs:enumeration value=“javascript”/>
         <xs:enumeration value=“c#”/>
         </xs:restriction>
         </xs:simpleType>
         </xs:element>
         <xs:element type=“xs:string” name=“basePath”/>
         <xs:element type=“pathsType” name=“paths”/>
      </xs:all>
   </xs:complexType>
</xs:schema>

### Listing 1: Example Contents of XSD File

In the example of Listing 1, the XSD file defines a set of protocols that can be used (e.g., rest, odata, grpc), a set of programming languages that can be used (e.g., j ava, javascript, c#), and a base path (basePath) and path (paths). Listing 2 provides non-limiting, example contents of an XML file:
<?xml version=“1.0” encoding=“UTF-8”?>
<OmnipotentApi xmlns:xsi=“http://www.w3.org/2001/XMLSchema-instance” xsi:noNamespaceSchemaLocation=“omnipotent-api.xsd”>
   <protocol>rest</protocol>
   <language>java</language>
   <basePath>/rest/omnipotentapi/v1</basePath>
   <paths>
      <path>
         <value>/users/{id}</value>
         <get>
         <parameters>
         <parameter>
         <name>id</name>
         <type>long</type>
         <scope>path</scope>
         </parameter>
         </parameters>
         <source>
<controller>org.omnipotentapi.api.UserController</controller><handlerMethod>get</handlerMethod>
   </source>
   </get>
   </path>
   <path>
      <value>/users</value>
      <get>
         <parameters>
         <parameter>
         <name>limit</name>
         <type>integer</type>
         </parameter>
         <parameter>
         <name>offset</name>
         <type>integer</type>
         </parameter>
         </parameters>
         <source>
         <controller>org.omnipotentapi.api.UserController </controller>
         <handlerMethod>find</handlerMethod>
         </source>
      </get>
      <post>
         <source>
         <controller>org.omnipotentapi.api.UserController </controller>
         <handlerMethod>create</handlerMethod>
         </source>
      </post>
   </path>
</paths>
</OmnipotentApi>

### Listing 2: Example Contents of XML File

In the example of Listing 2, the protocol is identified as rest, the programming language is identified as java, the base path is identified as/rest/omnipotentapi/v1, the path is identified as/users/{id}, an operation is identified as get, and multiple source code mappings are provided for. In some examples, the XML file is checked against the XSD file to ensure that the content of the XML file conforms with the definitions provided in the XSD file (e.g., programming language in the XML file is defined in the XSD file).

With continued reference to FIG. 2, the static code analyzer 206 analyzes source code based on the source code mapping(s) using syntactic analysis, lexical analysis, and semantic analysis. The static code analyzer 206 also sets up the code structure for consumption by the API generator 204. In some examples, a static code analyzer 206 can be provided for each programming language to account for different features of different languages.

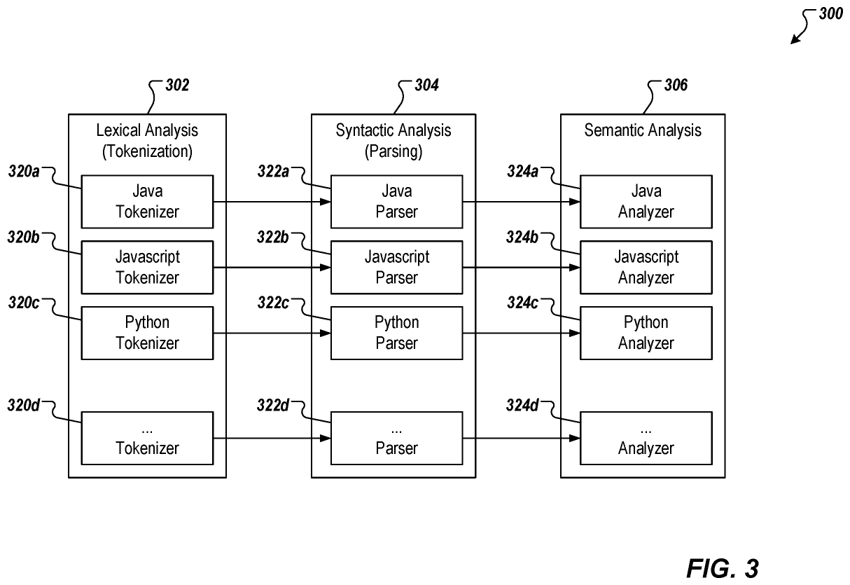

For example, FIG. 3 depicts a representation 300 of static code analysis in accordance with implementations of the present disclosure. In general, static code analysis refers to analyzing code without actually executing the code. The static code analysis includes lexical code analysis 302, syntactic code analysis 304, and semantic code analysis 306, each dependent on a particular programming language. For example, the lexical analysis 302 is performed by a language-specific tokenizer 320a, 320b, 320c, 320d, syntactic analysis 304 is performed by a language-specific parser 322a, 322b, 322c, 322d, and semantic analysis is performed by a language-specific analyzer 324a, 324b, 324c, 324d.

In some examples, the lexical code analysis 302 takes source code as input and provides a set of tokens, which can be described as a list of objects representing categorized input characters. In some examples, the syntactic code analysis 304 receives the set of tokens as input and provides a syntax tree, which can be described as an ordered tree of nodes and edges between nodes that describes the syntactic structure of the source code. For example, each programming language has grammar rules associated therewith, and corresponding programming language recognition tools, such as Java programming language and ANother Tool for Language Recognition (ANTLR) tool. Considering these non-limiting examples, ANTLR can parse a Java class into an abstract syntax tree (AST). For example, the Java class of Listing 3 can be parsed into the AST of Listing 4:
class GFG {
   public static void main(String[ ] args) {
      System.out.println(“Hello World!”);
   }
}

### Listing 3: Example Java Class

CLASS_DEF->CLASS_DEF [1:0]
   |--MODIFIERS->MODIFIERS [1:0]
   |--LITERAL_PUBLIC->public [1:0]
   |--LITERAL_CLASS->class [1:7]
   |--IDENT->GFG [1:13]
'-OBJBLOCK->OBJBLOCK [1:17]
         |--LCURLY->{[1:17]
         |--METHOD_DEF->METHOD_DEF [2:4]
         | |--MODIFIERS->MODIFIERS [2:4]
         | | |--LITERAL_PUBLIC->public [2:4]
         | | '--LITERAL_STATIC->static [2:11]
         | |--TYPE->TYPE [2:18]
         | | '--LITERAL_VOID->void [2:18]
         | |--IDENT->main [2:23]
         | |--LPAREN->([2:27]
         | |--PARAMETERS->PARAMETERS [2:34]
         | | '--PARAMETER_DEF->PARAMETER_DEF [2:34]
         | |--MODIFIERS->MODIFIERS [2:34]
         | | |--TYPE->TYPE [2:34]
         | | | '--ARRAY_DECLARATOR->[[2:34]
         | | | |--IDENT->String [2:28]
         | | | '--RBRACK->][2:35]
         | | | |--IDENT->args [2:37]
         | |--RPAREN->) [2:41]
         | '--SLIST->{[2:43]
         | |--EXPR->EXPR [3:26]
         | | '--METHOD_CALL->([3:26]
         | | |--DOT->. [3:18]
         | | | |--DOT->. [3:14]
         | | | | |--IDENT->System [3:8]
         | | | | '--IDENT->out [3:15]
         | | | '--IDENT->println [3:19]
         | | |--ELIST->ELIST [3:27]
         | | | '--EXPR->EXPR [3:27]
         | | | '--STRING_LITERAL->“Hello World!” [3:27]
         | | '--RPAREN->) [3:41]
         | |--SEMI->; [3:42]
         | '--RCURLY->}[4:4]
         | '--RCURLY->}[5:0]

### Listing 4: Example AST

In some examples, semantic code analysis 306 receives the syntax tree as input and provides a code structure, which can be described as method return types, parameter types, method names, and the like. As described in further detail herein, the code structure is used to automatically generate the boilerplate code and the glue code. In some examples, the parser provides a listener to implement during iterating the AST, where, when reach keyword METHOD_DEF, its name and handler method can be compared in the API metadata to get controller class, get parameters and return type, and generate this information into the code structure.

Referring again to FIG. 2, and in further detail, the static code analyzer 206 scans packages and public methods to set up the code structure. The static code analyzer 206 reads API metadata and collects source code mappings. Given keywords in the collected source code that is contained in the package to filter API packages, the static code analyzer 206 only takes care of the code structure of collected resources including, for example, source constructor, target method-related information, such as return type and parameters, and all related types of return types and parameter types. Listing 5 provides an example code structure that is output by the static code analyzer 206.
{
   “org.omnipotentapi.api.UserController”:[
      {
         “method”: “get”
         “requestParam”: “(Long)”,
         “responseParam”: “org.omnipotentapi.api.UserDTO”,
         “referLine”: 30
      }
   ]
}

### Listing 5: Example Output of Static Code Analysis

The API generator 204 receives the API metadata from the meta editor 204 and code structure from the static code analyzer 206. The code generation module 220 processes the API metadata and the code structure to generate boilerplate code and glue code. Each of the boilerplate code and the glue code are specific to the protocol that is defined in the API metadata and are executable to expose the API for consumption. The test code generation module 222 generates test code for integration testing of the exposed API. It can be noted that each language has corresponding code generation within the API generator 204.

In further detail, the API generator 204 reads the code structure generated by the static code analyzer 206 and the API metadata recorded in an XML file, and combines the code structure and API metadata to generate the boilerplate code, the glue code, and the test code. In some examples, a template is used, the template being specific to the programming language. A non-limiting example can include the Spring Model-View-Controller (MVC) (a Java framework for development of web applications, Bean Validation specification (defining a metadata model and an API that are used to validate JavaBeans for data integrity), and creation of a REST API. The following can be provided:
@RestController
@RequestMapping (“${basePath}”)
public class RestUserController {
   @Autowired
   private ${targetHandler}controller;
   @GetMapping(value=“${get_path}”, produces=MediaType. APPLICATION_JSON_VALUE)
   public ${returnType}getById(@PathVariable(“id”) Long id) {return this.controller.${HandleMethod}(id):
   }
}

### Listing 6: Example Template

Listing 7 provides an example of code generated by the API generator 204.
@RestController
@RequestMapping (“/rest/omnipotentapi/v1”)
public class RestUserController {
   @Autowired
   private UserController controller;
   @GetMapping(value=“/users/{id}”, produces=MediaType. APPLICATION_JSON_VALUE)
   public UserDTO getById(@PathVariable(“id”) Long id) {return this.controller.get(id);
   }
}

### Listing 7: Example API Code

In the example of Listing 7, the code in bold is glue code and the remaining code is boilerplate code.

In some examples, the test code is generated in a similar manner as the API code. For example, the test code can be generated using a template for a specific programming language and framework. A non-limiting example can include the Spring Test with the Junit testing framework and the Hamcrest Matcher. The following example test code can be provided.
@Test
public void whenGetUserById_thenReturnUser( ) throws Exception {
   mvc.perform(get(“/rest/omnipotentapi/v1/users/1”)) .andExpect(status( ).isOk( ));
}

### Listing 8: Example Test Code

The API validator 208 verifies correct execution of the generated APIs. In some examples, for each generated API, the API validator 208 tries to access the API to verify that the API is accessible. In some examples, the API validator generates a report with a list of APIs and the corresponding response (e.g., accessible, inaccessible). In this manner, for APIs that are problematic, users can debug.

After an API has been validated, the API is deployed for consumption. For example, the API can be deployed to an API layer within a cloud computing environment and exposed for consumption (e.g., API endpoint is exposed). The API enables access to, for example, one or more of a service layer and a data access layer of the cloud computing environment.

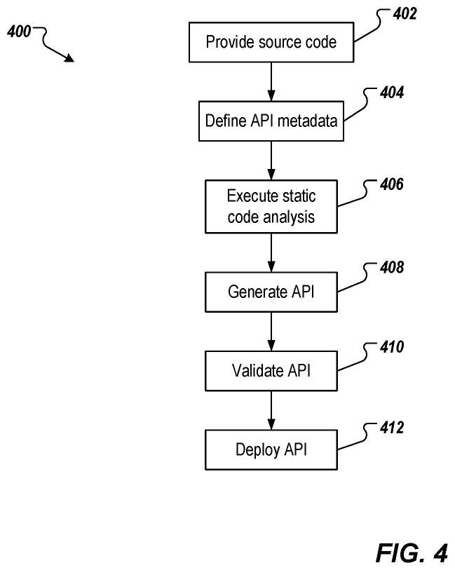

FIG. 4 depicts an example process 400 that can be executed in accordance with implementations of the present disclosure. In some examples, the example process 400 is provided using one or more computer-executable programs executed by one or more computing devices.

Source code is provided (402). For example, and as described herein, one or more users (e.g., developers) can develop source code that encodes functionality (logic) to be performed by a service. The source code can be compiled and deployed as a service within a cloud computing environment. API metadata is defined (404). For example, and as described herein, a user can define API metadata using the meta editor 202 of FIG. 2, the API metadata is descriptive of an API that is to be deployed to enable access to the service. In some examples, the API metadata is stored in a XML file.

Static code analysis is executed (406). For example, and as described herein, the static code analyzer 206 processes the API metadata, retrieves the source code of the service, and provides a code structure that is representative of the source code. An API is generated (408). For example, and as described herein, the API generator 204 processes the API metadata and the code structure to generate boilerplate code, glue code, and test code. The API is validated (410). For example, and as described herein, the API validator 208 validates whether the API is accessible. The API is deployed (412). For example, and as described herein, if the API is accessible (and meets other requirements), the API can be deployed to an API layer within a cloud computing environment and exposed for consumption (e.g., API endpoint is exposed). The API enables access to, for example, one or more of a service layer and a data access layer of the cloud computing environment.

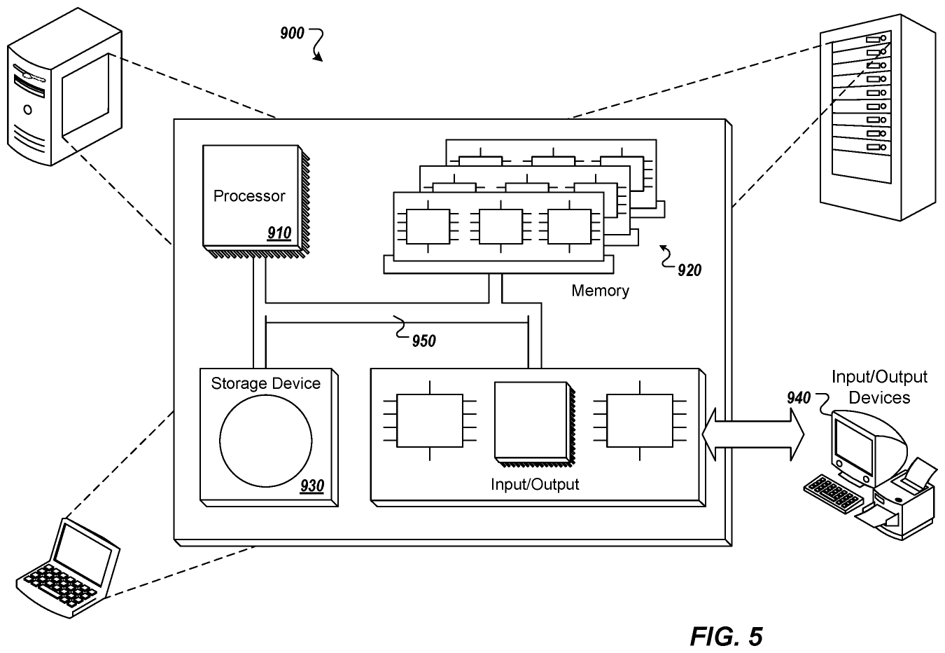

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for automated generation of application programming interfaces (APIs) for accessing services in cloud computing environments, the method being executed by one or more processors and comprising:
receiving, by a static code analyzer, API metadata descriptive of an API that is to be deployed to a cloud computing environment to enable access to a service;
processing, by the static code analyzer, the API metadata to retrieve source code that encodes functionality of the service and process the source code to generate a code structure that is descriptive of the source code;
generating, by an API generator, boilerplate code and glue code for the API using the API metadata and the code structure; and
deploying the API to the cloud computing environment.

2. The method of claim 1, wherein the code structure is generated by:
providing, by a tokenizer of the static code analyzer, a set of tokens from the source code;
generating, by a parser of the static code analyzer, a syntax tree using the set of tokens; and
defining, by an analyzer, the code structure from the syntax tree.

3. The method of claim 2, wherein the set of tokens comprises a list of objects representing categorized input characters.

4. The method of claim 1, wherein generating, by an API generator, boilerplate code and glue code for the API comprises reading the code structure generated by the static code analyzer and the API metadata, and combining at least a portion of the code structure and at least a portion of the API metadata.

5. The method of claim 1, wherein the API metadata is stored in an extensible markup language (XML) file and comprises a protocol, a language, a path, and a source code mapping.

6. The method of claim 5, wherein the source code is retrieved based on the source code mapping.

7. The method of claim 1, wherein deploying the API to the cloud computing environment is performed in response to validating the API.

8. A non-transitory computer-readable storage medium coupled to one or more processors and having instructions stored thereon which, when executed by the one or more processors, cause the one or more processors to perform operations for automated generation of application programming interfaces (APIs) for accessing services in cloud computing environments, the operations comprising:
receiving, by a static code analyzer, API metadata descriptive of an API that is to be deployed to a cloud computing environment to enable access to a service;
processing, by the static code analyzer, the API metadata to retrieve source code that encodes functionality of the service and process the source code to generate a code structure that is descriptive of the source code;
generating, by an API generator, boilerplate code and glue code for the API using the API metadata and the code structure; and
deploying the API to the cloud computing environment.

9. The non-transitory computer-readable storage medium of claim 8, wherein the code structure is generated by:
providing, by a tokenizer of the static code analyzer, a set of tokens from the source code;
generating, by a parser of the static code analyzer, a syntax tree using the set of tokens; and
defining, by an analyzer, the code structure from the syntax tree.

10. The non-transitory computer-readable storage medium of claim 9, wherein the set of tokens comprises a list of objects representing categorized input characters.

11. The non-transitory computer-readable storage medium of claim 8, wherein generating, by an API generator, boilerplate code and glue code for the API comprises reading the code structure generated by the static code analyzer and the API metadata, and combining at least a portion of the code structure and at least a portion of the API metadata.

12. The non-transitory computer-readable storage medium of claim 8, wherein the API metadata is stored in an extensible markup language (XML) file and comprises a protocol, a language, a path, and a source code mapping.

13. The non-transitory computer-readable storage medium of claim 12, wherein the source code is retrieved based on the source code mapping.

14. The non-transitory computer-readable storage medium of claim 8, wherein deploying the API to the cloud computing environment is performed in response to validating the API.

15. A system, comprising:
a computing device; and
a computer-readable storage device coupled to the computing device and having instructions stored thereon which, when executed by the computing device, cause the computing device to perform operations for automated generation of application programming interfaces (APIs) for accessing services in cloud computing environments, the operations comprising:
receiving, by a static code analyzer, API metadata descriptive of an API that is to be deployed to a cloud computing environment to enable access to a service;
processing, by the static code analyzer, the API metadata to retrieve source code that encodes functionality of the service and process the source code to generate a code structure that is descriptive of the source code;
generating, by an API generator, boilerplate code and glue code for the API using the API metadata and the code structure; and
deploying the API to the cloud computing environment.

16. The system of claim 15, wherein the code structure is generated by:
providing, by a tokenizer of the static code analyzer, a set of tokens from the source code;
generating, by a parser of the static code analyzer, a syntax tree using the set of tokens; and
defining, by an analyzer, the code structure from the syntax tree.

17. The system of claim 16, wherein the set of tokens comprises a list of objects representing categorized input characters.

18. The system of claim 15, wherein generating, by an API generator, boilerplate code and glue code for the API comprises reading the code structure generated by the static code analyzer and the API metadata, and combining at least a portion of the code structure and at least a portion of the API metadata.

19. The system of claim 15, wherein the API metadata is stored in an extensible markup language (XML) file and comprises a protocol, a language, a path, and a source code mapping.

20. The system of claim 19, wherein the source code is retrieved based on the source code mapping.
